(19) United States
(12) Patent Application Publication
(10) Pub. No.: US 2023/0349059 A1
(43) Pub. Date: Nov. 2, 2023

(54) APPARATUS AND METHOD FOR PERFORMING ELECTROLYSIS

(71) Applicant: Covestro Deutschland AG, Leverkusen (DE)

(72) Inventors: Oliver Goltz, Tönisvorst (DE); Rainer Sieben, Krefeld (DE); Andreas Bulan, Langenfeld (DE); Michael Grossholz, Leverkusen (DE)

(21) Appl. No.: 18/016,965

(22) PCT Filed: Aug. 24, 2021
(86) PCT No.: PCT/EP2021/073327

§ 371 Date: Jan. 19, 2023

(30) Foreign Application Priority Data
Aug. 24, 2020 (EP) 20192385.1

(51) Int. Cl. C25B 15/029; C25B 15/027; C25B 9/15; C25B 15/08

(52) U.S. Cl. CPC C25B 15/029; C25B 9/15; C25B 15/027; C25B 15/087

(57) ABSTRACT

The invention relates to an apparatus and a method for performing electrolysis with an originally oxygen-containing alkali hydroxide solution as an electrolyte precursor, wherein the pressure and temperature of the alkali hydroxide solution and the O₂ content thereof are set.

### CROSS REFERENCE TO RELATED APPLICATIONS

This application is a U.S. national stage application, filed under 35 U.S.C. § 371, of International Application No. PCT/EP2021/073327, which was filed on Aug. 24, 2021, and which claims priority to European Patent Application No. 20192385.1, which was filed on Aug. 24, 2020. The contents of each are hereby incorporated by reference into this specification.

### FIELD

The present invention relates to an apparatus and a process for operating an electrolysis with originally oxygen-containing alkali metal hydroxide solution as an electrolyte precursor, wherein in each case the pressure and temperature of the alkali metal hydroxide solution and the O₂ amount therein is adjusted.

### BACKGROUND

Oxygen-containing aqueous alkali metal hydroxide solutions, hereinbelow also referred to as lye, for example soda lye or potash lye, are formed or used in chloralkali electrolysis with an oxygen depolarized cathode (ODC) or alkaline water electrolysis. These alkali metal hydroxide solutions contain oxygen gas in dissolved or solvated form.

In the electrolyses lye-contacting materials employed typically include easy-to-use, chemically resistant and cost-effective material such as thermoplastics, such as polypropylene (hereinbelow also referred to as PP) (for example PP2222 or PP2250), PVC or PTFE. The use of C-PVC as a material is also possible. The material is preferably a thermoplastic.

A further advantage of using plastics materials and apparatuses for electrolysis is the electrical insulation effect thereof. Employable metallic materials, for example nickel, entail a great deal of electrical insulation work. Metallic materials are also not corrosion-resistant under all potentials. Since stray currents and potential transfers can also occur during electrolysis, preference should therefore be given to plastics-based materials.

In chloralkali electrolysis, polypropylene is preferably used for lye-contacting plant parts.

Polypropylene is resistant to aqueous solutions of inorganic salts and to almost all inorganic acids and bases, even at high concentrations and at temperatures above 60° C. Different PP types are available, for example hexagonal crystalline polypropylene. Thus for example various high molecular weight polypropylenes, such as for example homopolymers (PP-H, type 1) and random copolymers (PP-R, type 3), are employed in industrial pipe conduit construction. Block copolymers (PP-B, type 2) are also described. In contrast to normal monoclinic α-PP-H, hexagonal β-crystalline PP-H is produced by a specific nucleation and optimal processing. This material meets all the requirements of international standards for PP homopolymers. Flow media for PP pipe conduit systems include not only water but also aqueous solutions, acids, lyes and solvents. The degree of chemicals resistance of the polypropylene may be influenced by the pigmentation and by the homogeneity and structure of the crystalline phase (Schöpf, A., Schneider, H.: Polypropylen für Rohrleitungssysteme, Kunststoffe, 87 (1997) 2, pp. 198 - 201).

It must also be noted that in the case of pipe conduits and vessel linings the thermoplastic, in particular the PP material, must be processed, i.e. typically welded, as a result of which microstructure changes and also effects due to additives in the welded material can occur in the plastic.

It has been observed that during operation of the electrolysis apparatuses that use or liberate gaseous oxygen (O₂) in a half-cell reaction the plant parts fabricated from plastic or subjected to progressive material changes if said plant parts are in contact with lye. These material changes often lead to leaks in the apparatus. Such phenomena were evident on the employed plastics such as PP especially in the feed system of the electrolyte after a relatively lengthy operating time of about one year and were particularly pronounced at temperatures above 40° C. and pressures above ambient pressure.

It was found that these material changes likewise occurred on the weld seams of the plastic parts used. This resulted not only in external leakages but also in particle abrasion which led to blockage in the feed system, thus threatening plant availability and reliability of operation of an industrial plant. Plant availability for industrial chlorine systems should be more than two years, preferably more than 4 years.

Electrolysis apparatuses that utilize oxygen gas in a half-cell reaction usually comprise at least one so-called gas diffusion electrode, through which oxygen-containing gas can be supplied to the half-cell as a reactant. Electrolysis apparatuses liberating oxygen gas in a half-cell reaction are utilized for example for electrolysis of water, the so-called alkaline water electrolysis. In both cases at at least one electrode gaseous oxygen is introduced into the electrolyte in contact with said electrode as a result of the electrochemical process occurring at this electrode.

### SUMMARY

It was accordingly an object of the present invention to provide an electrolysis process and a corresponding apparatus wherein in each case the longevity of a plastic of the lye-contacting plant parts used as a material of the electrolysis apparatus is increased. The economy of the plant during operation and production and easy processability of the employed plastic as well as an efficient electrolysis process shall also be ensured.

This abovementioned object was achieved by adjusting the oxygen content of the aqueous alkali metal hydroxide solution to be fed into the half cell as electrolyte as well as the pressure thereof in the feed system of the electrolyzer.

The present invention therefore firstly provides a process for operating an electrolysis wherein at at least one electrode, as a result of the electrochemical process occurring at this electrode, gaseous oxygen is introduced into the electrolyte in contact with said electrode, characterized in that said electrolyte is introduced into the electrolysis cell and discharged therefrom again and said electrolyte to be introduced into the electrolysis cell is an alkaline, aqueous electrolyte containing alkali metal hydroxide and at an absolute pressure of 1 bar and a temperature of 20° C. an O₂ amount between 0 and 25 mg/L, wherein before introduction into the electrolysis cell the absolute pressure of the electrolyte for introduction is in the range from 1.2 bar to 3.5 bar and the temperature of the electrolyte for introduction is greater than 40° C.

### BRIEF DESCRIPTION OF DRAWINGS

FIG. 1 shows an example of an electrolyte feed and discharge as an electrolyte circuit on an electrolyzer;

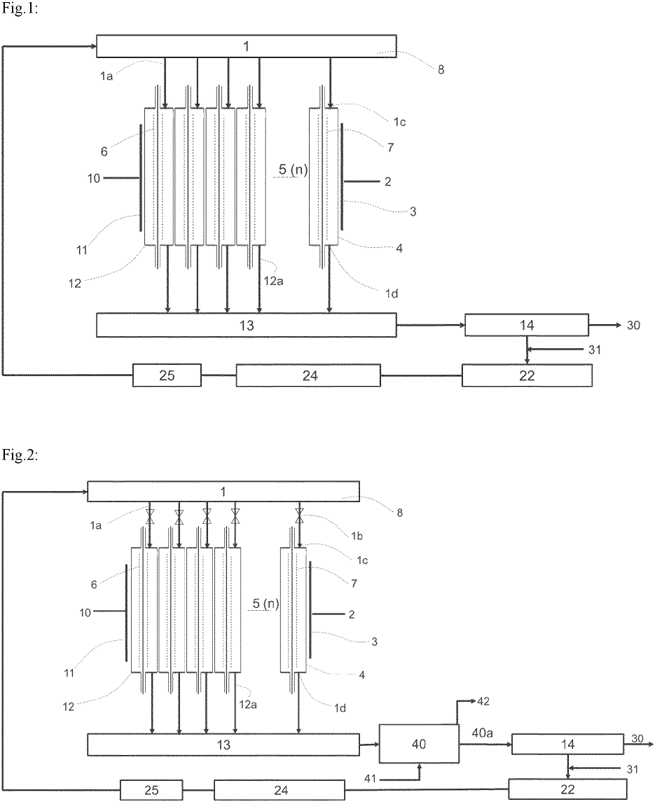

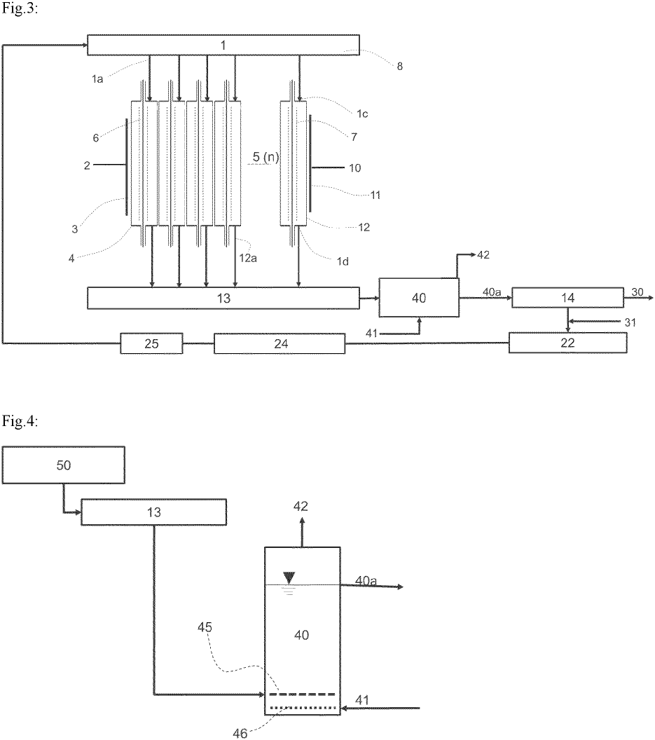

FIG. 2 shows an example of an electrolysis apparatus according to the invention having an apparatus for reducing the O₂ amount in the electrolyte
Electrolysis apparatus comprising
   (a) at least one electrolyzer (50), comprising
      at least one electrolysis cell (5) comprising at least one electrode (7) suitable for an electrochemical process where oxygen gas is introduced into the electrolyte of the electrolyzer (50) which is in contact with said electrode,
      at least one inlet (1c) for introducing electrolyte for introduction (8) with feeding at least into said at least one electrolysis cell (5), wherein the electrolyte for introduction (8) contains an O₂ amount of between 0 and 25 mg/L and has an absolute pressure in the range from 1.2 bar to 3.5 bar and a temperature of greater than 40° C.,
      at least one apparatus for pressurizing (22), in particular a pump,
      at least one outlet (1d) for discharging discharged electrolyte (9),
      and
   (b) at least one apparatus (40) for reducing the O₂ amount of aqueous, alkaline liquids for providing the electrolyte for introduction (8) which is in fluid communication with the at least one inlet (1c) for introducing electrolyte for introduction (8);

FIG. 3 shows an example of an electrolysis apparatus according to the invention for a water electrolysis;

FIG. 4 shows an example of a stripping column as an apparatus for reducing the O₂ amount 40 integrated into an electrolysis apparatus, wherein the stripping column 40 is configured such that the stripping gas 41 and the electrolyte are run in concurrent;

FIG. 5 shows an example of a stripping column as an apparatus for reducing the O₂ amount 40 integrated into an electrolysis apparatus, wherein the stripping column 40 is configured such that the stripping gas 41 and the electrolyte are run in countercurrent; and

FIG. 6 shows an example of a stripping column as an apparatus for reducing the O₂ amount 40 integrated into an electrolysis apparatus, wherein the stripping column 40 is configured such that the stripping gas 41 and the electrolyte are run in countercurrent and the stripping column 40 is filled with random packings 44.

### DETAILED DESCRIPTION

To determine the O₂ amount, a sample of the electrolyte to be determined is withdrawn, stored in a nitrogen or argon atmosphere and cooled to 20° C. The O₂ quantification is then carried out as described below. Storage under nitrogen or argon ensures that no O₂ can escape or be absorbed. Absorption would be possible through contact with air, since especially upon cooling of the sample O₂ solubility increases and O₂ could be absorbed.

As is known the O₂ amount of the electrolyte may be determined by optical oxygen measurement by fluorescence quenching methods (for example using the SE 740-Memosens® Oxygen Sensor from Knick Elektronische Messgeräte GmbH & Co. KG). Other sensors or else measurement of the redox potential may also be used as methods for determining the dissolved O₂ amount. All determinations of O₂ amounts performed in the context of the present invention were undertaken by fluorescence quenching methods. Unless otherwise stated, measurement was carried out on withdrawn samples at a temperature of 20° C. and an absolute pressure of 1 bar.

An electrolysis cell typically comprises a cathode half-shell, having a cathode, a catholyte feed and at least one catholyte discharge, an anode half-shell, wherein the anode half-shell is provided with at least one anolyte feed for introducing an anolyte, an anolyte discharge and an anode, and a separator arranged between the anode half-shell and the cathode half-shell for separation of the anode space and the cathode space, as well as electrical power lines for connecting the anode and the cathode with a direct current voltage source.

In order to produce industrial-scale amounts of product by electrolysis processes, large-area electrolysis cells and electrolyzers with a large number of electrolysis cells are needed. Industrial production volumes are understood here and hereinafter to mean amounts of product with more than 0.1 kg/(h*m²) per electrolysis cell. For this purpose, as is known from chloralkali electrolysis, electrolysis cells with an electrode area of more than 2 m² per electrolysis cell are typically used. The electrolysis cells are combined in groups of up to 100 in an electrolysis frame. A plurality of frames comprising electrolysis cells then form an “electrolyzer”. The capacity of an industrial electrolyzer is presently for example up to 30 000 t/a of chlorine and the respective equivalents of soda lye and optionally hydrogen.

The electrolyte to be introduced into the electrolysis cell (also “electrolyte for introduction”) is defined as the electrolyte immediately before it is introduced into the electrolysis cell and utilized for the electrochemical process at the electrode. According to the invention the electrolyte for introduction is an alkaline, aqueous electrolyte comprising alkali metal hydroxide and at a pressure of 1 bar and a temperature of 20° C. an O₂ amount of between 0 and 25 mg/L.

If a parameter range between two range limits is defined it goes without saying that these range limits are not included. By contrast, range limits in a parameter range are included if a parameter range is defined as from one limit to the other limit.

In a preferred embodiment a process is characterized in that said electrolyte flows through the electrolysis cell and to this end electrolyte is continuously introduced into the electrolysis cell and discharged therefrom again. This comprises continuously, i.e. simultaneously, introducing electrolyte for introduction into the electrolysis cell and discharging discharged electrolyte therefrom again.

In the process according to the invention for introduction into the electrolysis cell, preferably for continuous introduction into the electrolysis cell, the electrolyte for introduction is pressurized, for example using a pump, and before entry into the electrolysis cell has an absolute pressure in the range from 1.2 bar to 3.5 bar. The region of an electrolysis apparatus suitable for the process which is utilized for introducing the electrolyte for introduction is referred to by those skilled in the art as an introduction system or “feed system”.

The feed system of an electrolysis apparatus suitable for the process includes the storage vessel for the electrolyte, electrolyte-conducting pipe conduits and necessary control valves and butterfly valves, the electrolyte distributor, pumps, filters, heat exchangers and a wide variety of measured value acquisition instruments such as flowmeters or temperature and pressure sensors. The feed system is responsible for homogeneously distributing the electrolyte over all electrolysis cells in the electrolyzer.

Due to the pipelines and control valves installed in the feed system the pressure (preferably generated by a pump) of the electrolyte for introduction must be higher than ambient pressure (atmospheric pressure), i.e. at least 1.2 bar, in order that all electrolysis cells can be provided with a sufficient amount of electrolyte for introduction. A pressure is in turn preferably established after withdrawal of the electrolyte from the storage vessel and thus prevails in the feed system between the pressure-establishing apparatus, preferably a pump, arranged downstream of the storage vessel and the electrolysis cell.

The amount of electrolyte for introduction employed for the process according to the invention is preferably between 100 and 900 L/h. In the case of an electrolysis apparatus having for example 180 electrolysis cells operated simultaneously a volume flow of the electrolyte for introduction of 18 m³/h to 162 m³/h over the feed system for distributing the electrolyte for introduction into the electrolysis cells is preferred. The absolute pressure of the electrolyte for introduction in the feed system is up to 3.5 bar.

A preferred process according to the invention is characterized in that said electrolyte for introduction is at the feed conduits and/or the inlet into the electrolysis cell in contact with at least one thermoplastic material, preferably selected from polypropylene (PP), polyvinyl chloride (PVC) or polytetrafluoroethylene (PTFE).

Having regard to the temperature of the electrolyte for introduction it is essential according to the invention for said electrolyte for introduction to have a temperature of at least 40° C., preferably in the range from 60° C. to 85° C.

Electrolyte discharged from the electrolysis cell (also “discharged electrolyte”) is defined as electrolyte which after utilization for the electrochemical process at the electrode is discharged directly from the electrolysis cell. If the electrolysis apparatus utilized for performing the process according to the invention comprises more than one electrolysis cell in an electrolyzer the electrolyte discharged from the individual electrolysis cells may initially be combined in an electrolyte collector and then discharged from the electrolyzer.

In one embodiment of the process said electrolyte for introduction has a smaller O₂ amount than the discharged electrolyte. In a variant of this embodiment of the process preferred according to the invention said discharged electrolyte has an O₂ amount of at least 25 mg/L, preferably of at least 30 mg/L, very particularly preferably of at least 35 mg/L.

Processes preferred according to the invention are characterized in that said at least one electrode consumes oxygen gas (oxygen depolarized cathode) or evolves oxygen as a result of the electrochemical process occurring at said electrode.

If gaseous oxygen is consumed at the at least one electrode the process according to the invention preferably employs at least one oxygen depolarized cathode. In one embodiment the process according to the invention may be employed as a sodium chloride electrolysis using at least one oxygen depolarized cathode (ODC) (NaCl-ODC electrolysis for short). The basic principle of NaCl-ODC electrolysis may be found in the literature, for example Mousselem et al. J.Appl.Electrochem., 38(9), 1177-1194 (2008).

The principles of water electrolysis are described for example in chapter 6.3.4 in Volkmar M. Schmidt in “Elektrochemische Verfahrenstechnik” (2003 Wiley-VCH-Verlag; ISBN 3-527-29958-0) and shall not be elaborated on further here.

In the embodiment in the form of an NaCl-ODC electrolysis the employed alkaline, aqueous electrolyte (catholyte) is for example a soda lye. In the embodiment in the form of an NaCl-ODC electrolysis said electrolyte is preferably run such that a dilute lye, preferably soda lye, having a concentration in the range from 28% to 31% by weight is supplied to the electrolyzer as electrolyte for introduction and a more concentrated lye having a concentration in the range from 28.5% to 38% by weight is removed from the electrolyzer again as discharged electrolyte.

In the water electrolysis the employed alkaline, aqueous electrolyte (anolyte) is for example an aqueous solution of potassium hydroxide (potash lye). In the embodiment in the form of an alkaline water electrolysis said electrolyte is preferably run such that a dilute lye, preferably potash lye, having a concentration in the range from 20% to 28% by weight is supplied to the electrolyzer as electrolyte for introduction and a more concentrated lye having a concentration in the range from 20.5% to 33% by weight is removed from the electrolyzer again as discharged electrolyte.

The temperature of the electrolyte for introduction is preferably between 60° C. and 88° C. and the temperature and the volume flow are such that the discharged electrolyte has a temperature from 85° C. to 95° C.

To keep the cell voltage as low as possible the highest possible temperature and lowest possible lye concentration of the discharged electrolyte are sought.

However, in terms of the use of the lye a highest possible concentration is required and each operator therefore specifies their own optimum in terms of the desired uses.

Since in the NaCl-ODC electrolysis for example gaseous oxygen is added to the cathode as reactant or for example in the water electrolysis oxygen gas is generated at the anode and during operation of the electrolysis the gaseous oxygen comes into intensive contact with the alkaline, aqueous electrolyte containing alkali metal hydroxide the electrolyte discharged from the electrolysis cell has a higher oxygen content in the form of the O₂ amount of up to 40 mg/L. Consequently gaseous oxygen is introduced into the electrolyte and absorbed during operation of the electrolysis (in particular in dissolved or solvated form), thus increasing the O₂ amount present in the electrolyte.

The discharged electrolyte withdrawn from the electrolyzer is discharged into a storage tank via an electrolyte collector and a further pipe conduit optionally with butterfly valves and flow measurement means. A portion of the lye is in particular withdrawn in the NaCl-ODC electrolysis and sent for sale or to a consumer, the concentration optionally being increased by evaporative concentration. In NaCl-ODC electrolysis the remaining residue is diluted with water and supplied to the electrolysis via the feed system. It is also possible to pass only a substream through a heat exchanger, thus achieving the entry temperature of the lye required for the electrolyzer.

The electrolyte present in the storage vessel during operation preferably has an O₂ amount of between 0 and 25 mg O₂/L of electrolyte measured at an absolute pressure of 1 bar and a temperature of 20° C. The electrolyte from the storage vessel is returned to the electrolysis cells via the feed system after concentration adjustment of the alkali metal hydroxide. The pump conveys the electrolyte for introduction to the electrolysis cells at an absolute pressure in the feed system of between 1.2 and 3.5 bar. The pressure may for example be appropriately adjusted dimensioning the cross sections of the pipe conduits of the feed system such that the absolute pressure in the feed system assumes the desired value.

The absolute pressure of the electrolyte, in particular the soda lye, for introduction is preferably from 1.2 to 3.5 bar, particularly preferably from 1.2 to 3.0 bar, more preferably from 1.4 to 3.0 bar, very particularly preferably from 1.4 to 2.5 bar.

One embodiment of the process according to the invention is characterized in that before introduction into the electrolysis cell the electrolyte is subjected to a step of reducing the O₂ amount and then introduced into the electrolysis cell as said electrolyte for introduction. The electrolyte discharged from the at least one electrolysis cell is initially transferred into the storage tank and the reducing of the O₂ amount from the electrolyte is only undertaken before it is utilized for reuse from the storage tank and introduced into the electrolysis cell as electrolyte for introduction. However, in an embodiment of the process preferred according to the invention discharged electrolyte is after its discharging subjected to at least one step of reducing the O₂ amount and subsequently reused for providing electrolyte to be introduced into the electrolysis cell. This has the result that apparatus parts of the pipe conduit and storage vessel may be used for longer provided that plastics materials are used for the electrolyte-contacting pipe conduits or storage vessels.

As described above, the electrolyte discharged from the at least one electrolysis cell is preferably subjected to a reducing of the O₂ amount. After the reducing of the oxygen amount the electrolyte shall preferably have an O₂ amount of between 0 and 25 mg/L at an absolute pressure of 1 bar and a temperature of 20° C. The reducing of the oxygen amount is particularly preferably carried out before the discharged electrolyte transferred into the storage tank. The success of the stripping may be monitored by measuring the O₂ amount in the electrolyte discharged from the stripper.

In a preferred embodiment the discharged electrolyte is mixed with at least water to lower the alkalinity before the step of reducing the O₂ amount. It is in turn preferable when the alkali metal hydroxide concentration of the discharged electrolyte is adjusted to a concentration in the range from 28% to 31% by weight by addition of at least water before this step of reducing the O₂ amount.

If the process according to the invention is performed in the context of an NaCl-ODC electrolysis the electrolyte discharged on the cathode side of the electrolysis cell (discharged catholyte) is subjected to a step of reducing the O₂ amount.

Numerous methods may be used for the step of reducing the oxygen amount in the context of the process according to the invention. For example, the O₂ amount may be reduced by at least one step, selected from
stripping the discharged electrolyte with an inert gas, preferably with at least one inert gas selected from nitrogen, argon or mixtures thereof,
applying a vacuum by, for example, injecting the discharged electrolyte via a nozzle into a container whose absolute pressure is below 1 bar
applying ultrasound,
electrochemically reducing the oxygen,
adding at least one reducing agent for oxygen, for example hydrazine.

It is preferable according to the invention to achieve the reducing of the oxygen amount by subjecting the discharged electrolyte at least to a stripping with an inert gas as stripping gas, preferably with at least one inert gas selected from nitrogen, argon or mixtures thereof as stripping gas. In the present case those skilled in the art understand a stripping to be an at least partial desorption of the oxygen (O₂) present in the discharged electrolyte by contacting with at least one stripping gas to reduce the O₂ amount in the electrolyte. An inert gas is understood by those skilled in the art to be a gas which under its usage conditions in the context of the process according to the invention undergoes virtually no chemical reaction (i.e. no more chemical reactions compared to nitrogen as a comparative gas) and is distinct from oxygen.

The preferred volume flow of the electrolyte to the stripping apparatus used for reducing the oxygen amount is from 16 m³/h bis 160 m³/h.

The amount of stripping gas used per 750 L of electrolyte is preferably between 0.01 and 1 m³.

The preferred temperature of the electrolyte supplied to the stripping apparatus is 20° C. to 85° C.

Nitrogen is preferably employed as the stripping gas.

The preferred residence time of the stripping gas is from 20 to 120 seconds.

The absolute pressure in the stripping apparatus during stripping is between 0.6 to 1.2 bar.

The stripping apparatus employable for the reducing of the oxygen amount (hereinbelow also referred to as a “stripper”) may preferably have been constructed from at least one material selected from thermoplastic (preferably PP or GRP), rubberized steel or combinations thereof.

The stripping apparatus employable for the reducing of the oxygen amount preferably comprises at least one stripping space, into which both the electrolyte, preferably the discharged electrolyte, and at least one stripping gas may be introduced and contacted with one another and from which spent stripping gas and stripped electrolyte may be discharged. A stripping space having a height greater than its width and length is also referred to as a stripping column. A stripping column is preferably provided from a closed hollow tube which preferably comprises said inlets and outlets for the electrolyte, the stripping gas, the spent stripping gas and the stripped electrolyte.

In a preferred embodiment the stripper used for the process step of reducing the oxygen content comprises at least one, preferably cylindrical, stripping space having a base area of 0.3 m² to 1.2 m² and a height of 1 m to 3 m into which both the electrolyte, preferably the discharged electrolyte, and at least one stripping gas may be introduced and contacted with one another.

In a further embodiment of the stripper according to the invention the inlet, in particular in the form of nozzles, a coil or a perforated plate, through which the stripping gas is supplied is arranged at the lower end of the stripping space.

The electrolyte may comprise an inlet for the electrolyte at the upper end of the space for stripping or at the lower end of the space for stripping, wherein the inlet for the electrolyte is preferably arranged at the upper end of the space for stripping, in particular above the nozzles for supplying the stripping gas.

One example of a stripper in the form of a stripping column having an electrolyte inlet and a stripping gas inlet in each case at the lower end of the space for stripping is illustrated in FIG. 4. In this arrangement according to FIG. 4 the stripping gas and the electrolyte are passed through the stripping column in cocurrent.

The electrolyte discharged from the at least one electrolysis cell of the electrolyzer 50 is combined in the electrolyte collector 13 and from there supplied to a stripping column 40 from below. The stripping column 40 comprises a hollow tube having an overflow from which the lye supplied from below can be de discharged. During operation the stripping column is filled with electrolyte between the inlet and the outlet. The stripping gas 41 is supplied from below via a gas distributor 46, for example in the form of a coiled pipe system or a perforated plate or via one or more nozzles and flows upwards in cocurrent with the lye. The stripping gas exits the stripping column 40 above the electrolyte discharge 42 and may be supplied to an exhaust air treatment. The stripping gas 41 employed is preferably nitrogen. The liquor 40a depleted in O₂ is for example sent to a storage vessel or back to the electrolyzer 50.

It is very particularly preferable when the stripping gas and electrolyte are run in countercurrent in the stripper. It has in turn proven preferable when the inlet for the electrolyte is preferably arranged at the upper end of the space for stripping, in particular above the nozzles for supplying the stripping gas, and the outlet for the stripped electrolyte is arranged at the lower end of the space for stripping and the outlet for the gas formed from the stripping gas after the stripping is arranged at the upper end of the space for stripping.

A preferred embodiment of a stripping apparatus employable in the process according to the invention in the form of a stripping column in countercurrent is disclosed in FIG. 5. In this arrangement the stripping gas and the electrolyte are passed through the stripping column in countercurrent.

The electrolyte discharged from the at least one electrolysis cell 5 of the electrolyzer 50 is combined in the electrolyte collector 13 and from there supplied to a stripping column 40 from above. The stripping column 40 comprises a hollow tube with an electrolyte discharge at the bottom, from which the electrolyte supplied from above can be discharged after stripping. During operation the stripping column 40 is filled with electrolyte between the electrolyte inlet, which may be effected for example via a liquid distributor 45, and the electrolyte outlet, from which the O₂-poor lye 40a is discharged. The stripping gas 41 is supplied to the column from below via a gas distributor 46, for example a tube system consisting of, for example, nozzles, a coil or a perforated plate and runs upwards in countercurrent to the electrolyte. The utilized stripping gas 42 exits the stripping column above the electrolyte feed and may be supplied to an exhaust air treatment. The stripping gas employed is preferably nitrogen.

The stripping space of the stripper may generally contain random packings, as shown in FIG. 6, to increase the efficiency of the stripping. In addition to random packings it is also possible to employ structured packings, such as are known from distillation technology. In a preferred embodiment the stripper is provided in the stripping space with at least one random packing selected from spherical random packings with net structures or other cutouts and geometries, cylindrical rings such as for example Raschig rings, hollow cylinders, hollow half-cylinders or further customary embodiments.

The random packings may be produced from various materials, for example nickel, nickel plated stainless steel, plastic or ceramic.

A preferred embodiment of a stripping apparatus employable in the process according to the invention according to FIG. 5 in the form of a stripping column provided with random packings is disclosed in FIG. 6.

The electrolyte discharged from the at least one electrolysis cell 5 of the electrolyzer 50 is combined in the electrolyte collector 13 and from there supplied to a stripping column 40 from above. The stripping column comprises a hollow tube which is filled with random packings 44, for example Raschig rings, or structured packings such as are known from distillation technology. The stripping column is provided with a hollow tube at the bottom, from which the electrolyte supplied from above can be discharged after stripping. The supplied electrolyte may be applied to the random packings via a liquid distributor 45. During operation the stripping column is not completely filled with electrolyte between the inlet and the outlet. The stripping gas 41 is supplied from below and this may preferably also be effected from below via a gas distributor 46, for example a pipe system, for example in the form of a pipe conduit coil, or a perforated plate and flows upward in countercurrent to the electrolyte. The pent stripping gas 42 exits the stripping column above the electrolyte feed. The stripped electrolyte 40a exits the column below the stripping gas inlet. The stripping gas 41 employed is preferably nitrogen.

If the process according to the invention is performed in the context of an NaCl-ODC electrolysis, electrolyte discharged on the cathode side of the electrolysis cell (discharged catholyte) is subjected to a stripping, in particular using at least one stripping column (in particular a stripping column according to any of FIGS. 4, 5 or 6). The electrolyte collector in FIGS. 4, 5 and 6 would be referred to as a catholyte collector.

Performance of the process according to the invention may be performed using a suitable apparatus. The invention therefore further provides an electrolysis apparatus, comprising
(a) at least one electrolyzer comprising
   at least one electrolysis cell comprising at least one electrode suitable for an electrochemical process where oxygen gas is introduced into the electrolyte of the electrolyzer which is in contact with said electrode,
   at least one inlet for introducing electrolyte for introduction with feeding at least into said at least one electrolysis cell, wherein the electrolyte for introduction contains an O₂ amount of between 0 and 25 mg/L and has an absolute pressure of 1.2 bar to 3.5 bar (abs.) and a temperature of greater than 40° C.,
   at least one apparatus for pressurization,
   at least one outlet for discharging discharged electrolyte,
   and
(b) at least one apparatus for reducing the O₂ amount of aqueous, alkaline liquids for providing the electrolyte for introduction which is in fluid communication with the at least one inlet for introducing electrolyte for introduction.

Especially an electrolyzer as shown in FIG. 2 or FIG. 3 is preferentially suitable.

Employable apparatuses for pressurization include, for example, a pump.

In one embodiment the electrolysis apparatus additionally comprises a storage vessel for electrolytes. The storage vessel may preferably comprise a feed which is in fluid communication with the apparatus for reducing the O₂ amount, wherein the apparatus for reducing the O₂ amount is in fluid communication with the outlet for discharging discharged electrolyte. In this way the apparatus reduces the oxygen content of the discharged electrolyte before introduction into the reservoir vessel.

The reservoir vessel may additionally comprise at least one discharge for discharging electrolyte which is in fluid communication with the apparatus for pressurization, wherein the latter is in turn in fluid communication with at least one inlet for introducing electrolyte for introduction with feeding at least into said at least one electrolysis cell.

To adjust the temperature of the electrolyte to be introduced the electrolysis apparatus preferably comprises a heat exchanger which is in turn particularly preferably arranged between the inlet for introducing electrolyte to be introduced and the apparatus for pressurization (for example a pump) of the electrolyte withdrawn from the storage vessel. A filter, through which the electrolyte may be passed before introduction, may in turn be arranged between the heat exchanger and the inlet for introducing electrolyte for introduction.

The embodiments for features of the process according to the invention (in particular for the electrolyte for introduction, discharged electrolyte, the at least one electrode) are also preferably suitable, individually or in combination, for the apparatus, provided they are features of the apparatus. Examples include:

A preferred electrolysis apparatus is characterized in that said at least one electrode, in particular the electrode 7, is an oxygen depolarized cathode. In the context of this embodiment it is in turn particularly preferable to select an electrolysis apparatus according to FIG. 2.

The electrolysis apparatus according to the present invention preferably contains electrolyte for introduction (especially electrolyte 8 for introduction) which is an alkaline, aqueous electrolyte containing alkali metal hydroxide and an O₂ amount between 0 and 25 mg/L.

Reference numerals in the figures
1 electrolyte distributor
1a feed hose
1b valve for adjusting amount of lye
1c inlet for 8 into the electrolysis element
1d outlet for 9 from the electrolysis element
2 negative pole
3 cathode end plate
4 cathode half-shell
5 electrolysis element where n is number of electrolysis elements in electrolyzer
6 separator of anode and cathode
7 electrode suitable for an electrochemical process where oxygen gas is introduced into the electrolyte in contact with said electrode
8 electrolyte to be introduced
9 discharged electrolyte
10 positive pole
11 anode end plate
12 anode half-shell
12a discharge hose for discharged electrolyte 13 electrolyte collector
14 storage vessel
20 lye storage vessel
21 produced lye discharge
22 apparatus for pressurization (e.g. pump)
24 heat exchanger
25 filter
30 lye discharge
31 H2O addition for concentration adjustment
40 apparatus for reducing O₂ amount, preferably stripping column
40a electrolyte with reduced O₂ amount
41 feed, preferably for stripping gas
42 outlet, especially for gas for exhaust air treatment
44 random packings
45 liquid distributor
46 gas distributor
50 electrolyzer

### EXAMPLES

### Example 1 - Prior Art

An NaCl-ODC electrolyzer having an area per electrolytic cell of 2.7 m², where 158 elements were connected in series, was supplied with soda lye for each cathode half-shell. Each electrolysis cell was supplied with on average about 250 L/h of soda lye and the total lye volume flow to the electrolyzer was 39.5 m³/h. The absolute pressure of the electrolyte in the feed system was 4 bar and the temperature of the lye was 70° C. The O₂ amount of the electrolyte for introduction in the feed system was 28 mg/L.

The O₂ amount of the discharged electrolyte downstream of the electrolyzer, measured at a temperature of 20° C. and an absolute pressure of 1 bar, was 39 mg/L of soda lye measured with a SE 740-Memosens® Oxygen Sensor from Knick Elektronische Messgeräte GmbH & Co. KG. The concentration of the discharged electrolyte in the outlet of the electrolyzer was 31.5% by weight.

After a year of operation routine inspection revealed the first material changes at weld seams of the employed PP. After 2 years of operation the first leaks in the weld seams and extensive abrasion of the PP were observed and pipe conduit sections and vessel linings therefore needed to be replaced.

Operating time per year was about 8600 hours.

### Example 2 - Inventive

The electrolyzer from Example 1 was supplied in the same way, but the O₂ amount of the electrolyte for introduction in the feed was 20 g/L. The absolute pressure of the electrolyte in the feed system was 1.4 bar absolute due to the enlargement of the pipe cross sections and the use of valves with a lower pressure drop.

The electrolyte discharged from the electrolyzer was supplied to a stripper. The stripper was supplied with discharged electrolyte from above at a volume flow of 113 m³/h.

A stripper was made of PP reinforced with GRP. The stripper was designed as a hollow tube having a diameter of 90 cm and a fill height of 200 cm. Arranged at the bottom for introduction of the stripping gas nitrogen was a gas distributor in the form of a pipe conduit coil having 170 holes which each had a hole diameter of 3 mm and a hole spacing of 5 cm.

72 m³/h of N₂ were introduced. The residence time of the N₂ in the fill height was 63.6 s.

After 2 years of operation an inspection revealed no damage to PP-containing components.

1. A process for operating an electrolysis apparatus, the process comprising introducing an electrolyte into an electrolysis cell of the electrolysis apparatus and discharging the electrolyte from the electrolysis cell, wherein gaseous oxygen is introduced into the electrolyte in contact with at least one electrode of the electrolysis cell as a result of an electrochemical process occurring at the at least one electrode, wherein the electrolyte to be introduced into the electrolysis cell is an alkaline, aqueous electrolyte containing alkali metal hydroxide and at an absolute pressure of 1 bar and a temperature of 20° C. and an O₂ amount between 0 and 25 mg/L, wherein before introduction into the electrolysis cell the absolute pressure of the electrolyte for introduction is in the range from 1.2 bar to 3.5 bar and the temperature of the electrolyte for introduction is greater than 40° C.

2. The process as claimed in claim 1, wherein said electrolyte for introduction has a smaller O₂ amount than the discharged electrolyte.

3. The process as claimed in claim 1, wherein said discharged electrolyte has an O₂ amount of at least 25 mg/L at an absolute pressure of 1 bar and a temperature of 20° C.

4. The process as claimed in claim 1, wherein said electrolyte for introduction has a temperature in the range from 60° C. to 85° C.

5. The process as claimed in claim 1, wherein said electrolyte flows through the electrolysis cell, wherein said electrolyte is continuously introduced into the electrolysis cell and discharged therefrom again.

6. The process as claimed in claim 1, wherein said at least one electrode consumes oxygen gas or evolves oxygen as a result of the electrochemical process occurring at said at least one electrode.

7. The process as claimed in claim 1, wherein said electrolyte for introduction is at the-feed conduits and/or the an inlet into the electrolysis cell in contact with at least one thermoplastic material.

8. The process as claimed in claim 1, wherein the electrolyte is subjected to a step of reducing the O₂ amount and then introduced into the electrolysis cell as said electrolyte for introduction.

9. The process as claimed in claim 1, wherein discharged electrolyte is subjected to at least one step of reducing the O₂ amount and subsequently reused for providing electrolyte to be introduced into the electrolysis cell.

10. The process as claimed in claim 9, wherein discharged electrolyte is mixed with at least water to lower the alkalinity before the step of reducing the O₂ amount.

11. The process as claimed in claim 8, wherein an inert gas is employed to reduce the O₂ amount.

12. An electrolysis apparatus comprising
(a) at least one electrolyzer, comprising
at least one electrolysis cell comprising at least one electrode suitable for an electrochemical process where oxygen gas is introduced into the electrolyte of the electrolyzer which is in contact with said electrode,
at least one inlet for introducing electrolyte for introduction with feeding at least into said at least one electrolysis cell, wherein the electrolyte for introduction contains an O₂ amount of between 0 and 25 mg/L and has an absolute pressure in the range from 1.2 bar to 3.5 bar and a temperature of greater than 40° C.,
at least one apparatus for pressurizing,
at least one outlet for discharging discharged electrolyte,
and
(b) at least one apparatus for reducing the O₂ amount of aqueous, alkaline liquids for providing the electrolyte for introduction which is in fluid communication with the at least one inlet for introducing electrolyte for introduction.

13. The electrolysis apparatus as claimed in claim 12, wherein said electrode is an oxygen depolarized cathode.

14. The electrolysis apparatus as claimed in claim 12, wherein the electrolysis apparatus contains electrolyte for introduction, wherein the electrolyte for introduction is an alkaline, aqueous electrolyte containing alkali metal hydroxide and an O₂ amount of between 0 and 25 mg/L.

15. The electrolysis apparatus as claimed in claim 12, wherein the electrolysis apparatus additionally contains a storage vessel for electrolytes, the storage vessel comprising at least one feed which is in fluid communication with the apparatus for reducing the O₂ amount, wherein the apparatus for reducing the O₂ amount is in fluid communication with the outlet for discharging discharged electrolyte.

16. The process as claimed in claim 3, wherein said discharged electrolyte has an O₂ amount of at least 35 mg/L at an absolute pressure of 1 bar and a temperature of 20° C.

17. The process as claimed in claim 7, wherein the at least one thermoplastic material is selected from polypropylene (PP), polyvinyl chloride (PVC), or polytetrafluoroethylene (PTFE).

18. The process as claimed in claim 11, wherein the inert gas comprises nitrogen, argon, or a mixture thereof.

19. The electrolysis apparatus as claimed in claim 12, wherein the at least one apparatus for pressurizing comprises a pump.
